(19) United States
(12) Patent Application Publication
(10) Pub. No.: US 2017/0347107 A1
(43) Pub. Date: Nov. 30, 2017

(54) BIT ALLOCATION METHOD AND VIDEO ENCODING DEVICE

(71) Applicant: MStar Semiconductor, Inc., Hsinchu Hsien (TW)

(72) Inventors: Shu-Wei Teng, Hsinchu Hsien (TW); Chia-Chiang Ho, Hsinchu Hsien (TW)

(21) Appl. No.: 15/337,121

(22) Filed: Oct. 28, 2016

(30) Foreign Application Priority Data
May 26, 2016 (TW) 105116412

(51) Int. Cl. H04N 19/176; H04N 19/184

(52) U.S. Cl. CPC H04N 19/176; H04N 19/184

(57) ABSTRACT

A bit allocation method applied to an encoding device includes: performing a high frequency operation on a plurality of encoding blocks of a first frame to obtain a first block texture weight corresponding to a first encoding block among the encoding blocks; performing a protected color detection operation on the encoding blocks to obtain a first block protected color weight corresponding to the first encoding block; calculating a first bit weight corresponding to the first encoding block according to the first block texture weight and the first block protected color weight; and performing bit allocation for the first encoding block according to the first bit weight.

This application claims the benefit of Taiwan application Serial No. 105116412, filed May 26, 2016, the subject matter of which is incorporated herein by reference.

### BACKGROUND OF THE INVENTION

### Field of the Invention

The invention relates in general to a bit allocation method and a video encoding device, and more particularly to a bit allocation method and a video encoding device capable of optimizing perceptual visual quality.

### Description of the Related Art

Bit allocation is a fundamental task in video encoding. During processes of video transmission and storage, network bandwidth and storage resources are limited. One main goal of bit allocation is, under the premise of guaranteeing the optimum video encoding quality, allocating appropriate numbers of bits to different encoding blocks in response to different characteristics of these encoding blocks. As such, not only a video stream outputted may render an optimum perceptual visual quality, but also transmission and storage restrictions are satisfied at the same time. In general, an encoding device may allocate a greater number of bits for an encoding block that attracts more attention to the human eye to reduce the distortion of that area. In contrast, an encoding device may allocate a smaller number of bits to an encoding block that appears more negligible to the human eye to save the number of bits consumed. Therefore, it is one common goal of the technical field to enhance the perceptual visual quality.

### SUMMARY OF THE INVENTION

The invention is directed to a bit allocation method and a video encoding device to optimize subjective perceptual visual quality.

The present invention discloses a bit allocation method applied to a video encoding device. The bit allocation method includes: performing a high frequency operation on a plurality of encoding blocks of a first frame to obtain a first block texture weight corresponding to a first encoding block among the plurality of encoding blocks; performing a protected color detection operation on the plurality of encoding blocks to obtain a first block protected color weight corresponding to the first encoding block; calculating a first bit weight corresponding to the first encoding block according to the first block texture weight and the first block protected color weight; and performing bit allocation for the first encoding block according to the first bit weight.

The present invention further discloses a video encoding device. The video encoding device includes: a texture calculating circuit, performing a high frequency operation on a plurality of encoding blocks of a first frame to obtain a first block texture weight corresponding to a first encoding blocks among the plurality of encoding blocks; a protected color calculating circuit, performing a protected color detection operation on the plurality of encoding blocks to obtain a first block protected color weight corresponding to the first encoding block; a combining circuit, coupled to the texture calculating circuit and the protected color calculating circuit, calculating a first bit weight corresponding to the first encoding block according to the first block texture weight and the first block protected color weight; and an allocating circuit, coupled to the combining circuit, performing bit allocation for the first encoding block according to the first bit weight.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a flowchart of a bit allocation process according to an embodiment of the present invention;

FIG. 2 is a schematic diagram of a frame;

FIG. 3 is a flowchart of a texture analysis process according to an embodiment of the present invention;

FIG. 4 is a protected color analysis process according to an embodiment of the present invention;

FIG. 5 is a block diagram of a video encoding device according to an embodiment of the present invention; and

FIG. 6 is a block diagram of a video encoding device according to another embodiment of the present invention.

### DETAILED DESCRIPTION OF THE INVENTION

For applications associated with video surveillance or video conference, the human eye is more attracted to distortion in flat and gradient areas in an image than edges or creases of an object. In general, a flat and gradient area has a lower spatial texture complexity, whereas an edge or crease of an object has a higher spatial texture complexity. Further, in an image, image blocks containing facial expressions have a higher protected color pixel count, i.e., skin color pixel count. In the present invention, the spatial texture complexity and the protected color pixel count are used as the basis for bit allocation to enhance perceptual visual quality.

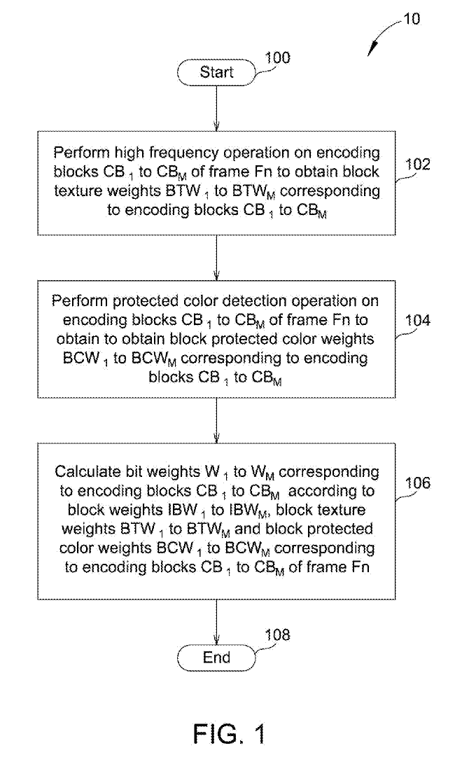

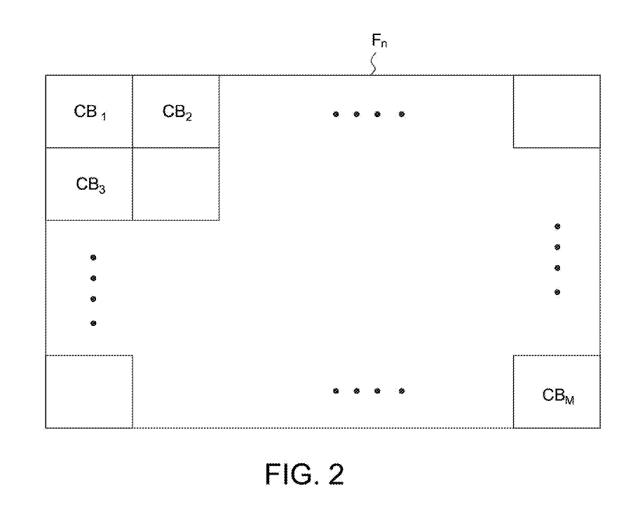

FIG. 1 shows a flowchart of a bit allocation process 10 according to an embodiment of the present invention. FIG. 2 shows a schematic diagram of a frame Fₙ. As shown in FIG. 2, the frame Fₙ includes a plurality of encoding blocks CB₁ to CB_{M}. According to the characteristics of the encoding blocks CB₁ to CB_{M}, a video encoding device may allocate appropriate numbers of bits to the encoding blocks CB₁ to CB_{M}. More specifically, according to spatial texture complexities of the encoding blocks CB₁ to CB_{M} and protected color pixel counts in the encoding blocks CB₁ to CB_{M}, the video encoding device allocates appropriate numbers of bits to the encoding blocks CB₁ to CB_{M}. The bit allocation process 10 may be performed by a video encoding device, and includes following steps.

In step 100, the bit allocation process 10 begins.

In step 102, a high frequency operation is performed on the encoding blocks CB₁ to CB_{M} of the frame Fₙ to obtain block texture weights BTW₁ to BTW_{M} corresponding to the encoding blocks CB₁ to CB_{M}.

In step 104, a protected color detection operation is performed on the encoding blocks CB₁ to CB_{M} of the frame Fₙ to obtain block protected color weights BCW₁ to BCWₘ corresponding to the encoding blocks CB₁ to CB_{M}.

In step 106, bit weights W₁ to W_{M} corresponding to the encoding blocks CB₁ to CB_{M} are calculated according to block weights IBM₁ to IBW_{M}, the block texture weights BTW₁ to BTW_{M}, and the block protected color weights BCW₁ to BCWₘ corresponding to the encoding blocks CB₁ to CB_{M} of the frame Fₙ.

In step 108, the bit allocation process 10 ends.

Details of the bit allocation process 10 are given below. Step 102 is for obtaining the spatial texture complexities corresponding to the encoding blocks CB₁ to CB_{M}. In step 102, the video encoding device performs a high frequency operation (e.g., an edge detection operation) on the encoding blocks CB₁ to CB_{M} of the frame Fₙ to obtain the block texture weights BTW₁ to BTW_{M} corresponding to the encoding blocks CB₁ to CB_{M}, i.e., to obtain a block texture weight BTWᵢ corresponding to an encoding block CBⱼ among the encoding blocks CB₁ to CB_{M}. In overall, the video encoding device first performs a high frequency operation on the encoding blocks CB₁ to CB_{M} to obtain block texture complexities BT₁ to BT_{M} corresponding to the encoding blocks CB₁ to CB_{M}, and then performs a normalization operation on the block texture complexities BT₁ to BT_{M} to obtain the block texture weights BTW₁ to BTW_{M} corresponding to the encoding blocks CB₁ to CB_{M}. In other words, for the encoding block CBᵢ, the block texture weight BTWᵢ is obtained from the calculation

$${BTW}_{i} = {BT}_{i} / {\sum }_{m = 1}^{M} {BT}_{m} ,$$

i.e., the BTWᵢ is a ratio of the block texture complexity BTᵢ to a sum of the block texture complexities BT₁ to BT_{M}.

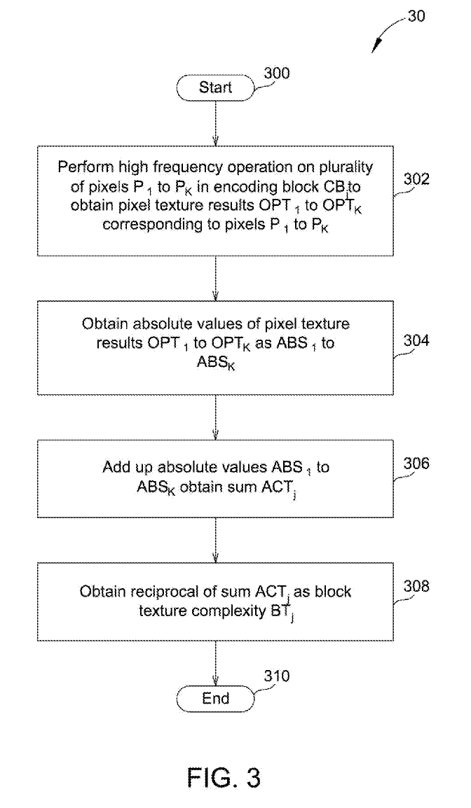

Further, the operation process of a high frequency operation that the video encoding device performs on any encoding block CBⱼ among the encoding blocks CB₁ to CB_{M} to obtain the block texture complexity BTⱼ corresponding to the encoding block CBⱼ is described in detail with reference to FIG. 3 below. FIG. 3 shows a flowchart of a texture analysis process 30 according to an embodiment of the present invention. The texture analysis process 30 may be performed by a video encoding device, and includes following steps.

In step 300, the texture analysis process 30 begins.

In step 302, a high frequency operation is performed on a plurality of pixels P₁ to P_{K} in the encoding block CBⱼ to obtain pixel texture results OPT₁ to OPT_{K} corresponding to the pixels P₁ to P_{K}.

In step 304, absolute values of the pixel texture results OPT₁ to OPT_{K} are obtained as ABS₁ to ABS_{K}.

In step 306, the absolute values ABS₁ to ABS_{K} are added up to obtain a sum ACTⱼ.

In step 308, a reciprocal of the sum ACTⱼ is obtained as the block texture complexity BTⱼ.

In step 310, the texture analysis process 30 ends.

In step 302, the video encoding device performs a high frequency operation on the pixels P₁ to P_{K} in the encoding block CBⱼ. For example, the video encoding device may perform a spatial sharpening filter operation (i.e., a high frequency filter operation) on the pixels P₁ to P_{K} to reinforce image details of the encoding block CBⱼ and to emphasize changes in color intensities of the encoding block CBⱼ. The spatial sharpening filter operation is not limited to being realized by a certain method. For example, the video encoding device may first perform a horizontal gradient operation and a vertical gradient operation on the pixels P₁ to P_{K} to obtain horizontal gradient operation results gh1 to gh_{K} and vertical gradient operation results gv1 to gv_{K}, respectively, and then obtain the pixel texture results OPT₁ to OPT_{K} according to the horizontal gradient operation results gh1 to gh_{K} and the vertical gradient operation results gv1 to gv_{K}. A kernel of the horizontal gradient operation may be [1, 0, −1], and a kernel of the vertical gradient operation may be [1, 0, −1]^{T}. The video encoding device may calculate a pixel texture result OPTₖ as a sum of an absolute value of a horizontal gradient operation result ghₖ and an absolute value of a vertical gradient operation gvₖ, i.e., OPTₖ=abs(ghₖ)+(abs(gvₖ), where abs( ) represents an absolute value calculation. Thus, the video encoding device may obtain the pixel texture results OPT₁ to OPT_{K} corresponding to the pixels P₁ to P_{K}. Further, in another embodiment, the spatial sharpening filter operation may be realized through a two-dimensional Laplacian operation, whose kernel may be

$$[ \begin{matrix}0 & 1 & 0 \\ 1 & - 4 & 1 \\ 0 & 1 & 0\end{matrix} ] or [ \begin{matrix}1 & 1 & 1 \\ 1 & - 8 & 1 \\ 1 & 1 & 1\end{matrix} ] .$$

In step 304, after the high frequency operation is performed on the pixels P₁ to P_{K} in the encoding block CBⱼ, the video encoding device obtains the absolute values of the pixel texture results OPT₁ to OPT_{K} as ABS₁ to ABS_{K}. In step 306, the video encoding device obtains a sum of the absolute values ABS₁ to ABS_{K} as

$${ACT}_{j} = {\sum }_{k = 1}^{K} {ABS}_{k} .$$

In step 306, the reciprocal of the sum ACTⱼ is obtained as the block texture complexity BTₗ, i.e., BTₗ=1/ACTⱼ. Through step 102 and the texture analysis process 30, the video encoding device obtains the block texture complexities BT₁ to BT_{M} corresponding to the encoding blocks CB₁ to CB_{M}, and accordingly obtains the block texture weights BTW₁ to BTW_{M} corresponding to the encoding blocks CB₁ to CB_{M}.

Further, step 104 obtains the protected color pixel counts corresponding to the encoding blocks CB₁ to CB_{M}. In step 104, the video encoding device performs a protected color detection operation on the encoding blocks CB₁ to CB_{M} of the frame Fₙ to obtain the block protected color weights BCW₁ to BCW_{M} corresponding to the encoding blocks CB₁ to CB_{M}, i.e., to obtain a protected color weight BCWᵢ of the encoding block BCiᵢ among the encoding blocks CB₁ to CB_{M}. In overall, the video encoding device first performs a protected color detection operation on the encoding blocks CB₁ to CB_{M} to obtain the block protected color levels BC₁ to BC_{M} corresponding to the encoding blocks CB₁ to CB_{M}, and then performs a normalization operation on the block protected color levels BC₁ to BC_{M} to obtain the block protected color weights BCW₁ to BCW_{M} corresponding to the encoding blocks CB₁ to CB_{M}. In other words, for the encoding block CBi, the block protected color weight BCWᵢ may be obtained from the calculation

$${BCW}_{i} = {BC}_{i} / {\sum }_{m = 1}^{M} {BC}_{m} ;$$

that is, the block protected color weight BCW₁ is a ratio of the block protected color level BCᵢ to a sum of the block protected color levels BC₁ to BC_{M}. Wherein, the block protected color level BCᵢ of the encoding block CBᵢ is associated with the protected color pixel count of the encoding block CB₁.

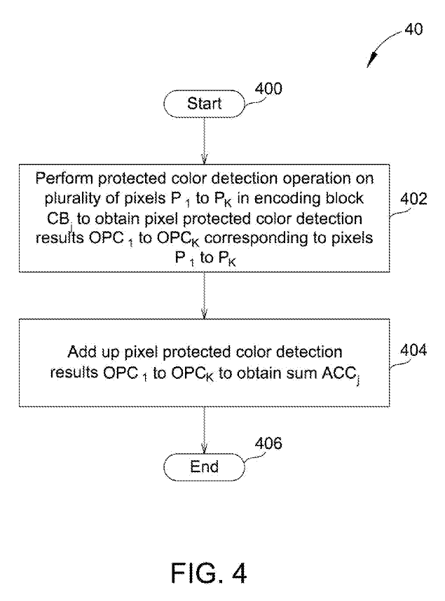

The operation process of the protected color detection operation that the video encoding device performs on any encoding block CBⱼ among the encoding blocks CB₁ to CB_{M} to obtain a block protected color level BCⱼ corresponding to the encoding block CBⱼ is described in detail with reference to FIG. 4. FIG. 4 shows a flowchart of a protected color analysis process 40 according to an embodiment of the present invention. The protected color analysis process 40 may be performed by a video encoding device, and includes following steps.

In step 400, the protected color analysis process 40 begins.

In step 402, a protected color detection operation is performed on a plurality of pixels P₁ to P_{K} in the encoding block CBⱼ to obtain pixel protected color detection results OPC₁ to OPC_{K} corresponding to the pixels P₁ to P_{K}.

In step 404, the pixel protected color detection results OPC₁ to OPC_{K} are added up to obtain a sum ACCⱼ.

In step 406, the protected color analysis process 40 ends.

In step 402, the video encoding device performs a protected color detection operation on the pixels P₁ to P_{K} in the encoding block CBⱼ to obtain the pixel protected color detection results OPC₁ to OPC_{K} corresponding to the pixels P₁ to P_{K}. A pixel protected color detection result OPCₖ represents whether an image color displayed by a pixel Pₖ satisfies a predetermined color, and may be in a value 0 or 1. The image color displayed by the pixel Pₖ satisfies a predetermined color when the value of the pixel protected color detection result OPCₖ is 1, otherwise the image color displayed by the pixel Pₖ is not the predetermined color when the value of the pixel protected color detection result OPCₖ is 0. For example, the protected color detection operation may be a skin color detection operation generally known to one person skilled in the art. The skin color detection operation determines whether values of luminance Y, a blue chroma component Cb and a red chroma component Cr of the pixel Pₖ are in a predetermined range to generate the pixel protected color detection result OPCₖ in a value 0 or 1. In step 404, the video encoding device adds up the pixel protected color detection results OPC₁ to OPC_{K} of the encoding block CBⱼ to obtain the sum ACCⱼ corresponding to the encoding block CBⱼ. The sum ACCⱼ represents the protected color pixel count of the encoding block CBⱼ. In one embodiment, the video encoding device may directly obtain the block protected color levels BC₁ to BC_{M} as sums ACC₁ to ACCₘ corresponding to the encoding blocks CB₁ to CB_{M}. Preferably, the video encoding device may perform a low-pass filter operation on the sums ACC₁ to ACC_{M}, e.g., a low-pass filter operation having a kernel

$$[ \begin{matrix}0 & 1 & 1 \\ 2 & 4 & 0 \\ 0 & 0 & 0\end{matrix} ] ,$$

to generate the block protected color levels BC₁ to BC_{M} corresponding to the encoding blocks CB₁ to CB_{M}.

After the video encoding device performs step 104 and the protected color analysis process 40 on the frame Fₙ, the block protected color weights BCW₁ to BCW_{M} corresponding the encoding blocks CB₁ to CB_{M} can be obtained. After obtaining the block texture weights BTW₁ to BTW_{M} and the block protected color weights BCW₁ to BCW_{M} corresponding the encoding blocks CB₁ to CB_{M}, in step 106, the video encoding device calculates the weight Wᵢ corresponding to the encoding block CBᵢ in the frame Fₙ according to the block weight IBWᵢ the block texture weight BTWᵢ and the block protected color weight BCWᵢ corresponding to the encoding block CBᵢ in the frame Fₙ. Wherein, the block weights IBW₁ to IBW_{M} may be provided by the video encoding device, which may determine these block weights IBW₁ to IBW_{M} corresponding to the encoding blocks CB₁ to CB_{M} according to characteristics of a previous frame Fₙ₋₁ of the frame Fₙ (e.g., the block weight IBWᵢ may be a bit weight in the frame Fₙ₋₁ corresponding to the encoding block CBᵢ).

More specifically, the video encoding device calculates a combination of the block weight IBWᵢ, the block texture weight BTWᵢ and the block protected color weight BCWᵢ corresponding to the encoding block CBᵢ in the frame Fₙ as the bit weight Wᵢ corresponding to the encoding block CBᵢ in the frame Fₙ. The method for calculating the combination is not limited. For example, the bit weight Wᵢ may be a linear combination of the block weight IBWᵢ the block texture weight BTWᵢ and the block protected color weight BCWᵢ corresponding to the encoding block CBᵢ i.e., the bit weight Wᵢ=αIBWᵢ+βBTWᵢ+γBCWᵢ, wherein α, β and γ may be constants that are adjustable based on actual conditions.

In another embodiment, the video encoding device may re-blend the block texture weight and the block protected color weight to obtain a first blended result, and blend the first blended result with the block weight to obtain the bit weight. More specifically, for each encoding block CB, the video encoding device may calculate a blended weight BBWᵢ, which may be a linear combination of the block texture weight BTWᵢ and the block protected color weight BCWᵢ (i.e., the blended weight BBWᵢ is calculated as BBWᵢ=ζBTWᵢ+δBCWᵢ, where ζ and δ are constants that are adjustable based on actual conditions). Thus, the video encoding device may obtain the blended weights BBW₁ to BBW_{M} corresponding to the encoding blocks CB₁ to CB_{M}. Next, the video encoding device may perform a low-pass filter operation on the blended weights BBW₁ to BBW_{M} to obtain low-pass weights BLW₁ to BLW_{M}, with a kernel of the low-pass filter operation being

$$[ \begin{matrix}1 & 1 & 1 \\ 1 & 4 & 0 \\ 0 & 0 & 0\end{matrix} ] .$$

The video encoding device may then obtain a first blended result FWᵢ corresponding to the encoding block CBᵢ as the blended weight BBWᵢ corresponding to the encoding block CBᵢ or obtain the first blended result FWᵢ as the low-pass weight BLWᵢ corresponding to the encoding block CBᵢ. For example, when the blended weight BBWᵢ is greater than or equal to the low-pass weight BLWᵢ, the video encoding device obtains the first blended result FWᵢ as the blended weight BBWᵢ; when the blended weight BBWᵢ is smaller than the low-pass weight BLWᵢ, the video encoding device obtains the first blended result FWᵢ as the low-pass weight BLWᵢ. In other words, the first blended result FWᵢ may be represented as

$${FW}_{i} = \{ \begin{matrix}{BBW}_{i} , {BBW}_{i} \geq {BLW}_{i} \\ {BLW}_{i} , {BBW}_{i} < {BLW}_{i}\end{matrix} .$$

The video encoding device then calculates a linear combination of the first blended result FWᵢ and the block weight IBWᵢ as the bit weight Wᵢ, i.e., the bit weight Wᵢ is calculated as Wᵢ=μIBWᵢ+νFWᵢ, where μ and ν are constants that are adjustable based on actual conditions. Thus, the video encoding device may obtain the bit weights W₁ to W_{M} corresponding to the encoding blocks CB₁ to CB_{M}.

Therefore, according to the bit allocation process 10, the video encoding device may obtain the bit weights W₁ to W_{M} corresponding to the encoding blocks CB₁ to CB_{M}, and allocate appropriate numbers of bits to the encoding blocks CB₁ to CB_{M} according to the bit weights W₁ to W_{M} corresponding to the encoding blocks CB₁ to CB_{M}, such that the video encoding device may perform video encoding on the encoding blocks CB₁ to CB_{M} according to the numbers of bits allocated to the encoding blocks CB₁ to CB_{M}.

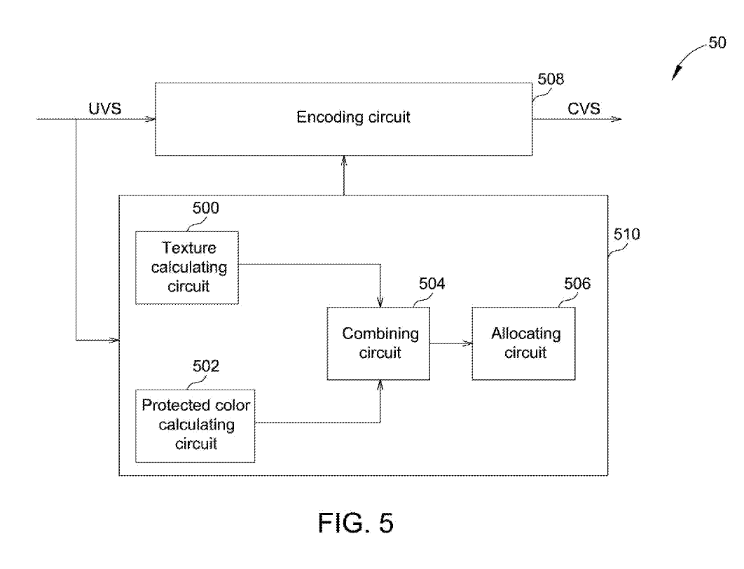

FIG. 5 shows a block diagram of a video encoding device 50 according to an embodiment of the present invention. The video encoding device 50 includes a bit rate control circuit 510 and an encoding circuit 508. The video encoding device 50 receives a video data stream UVS and performs video encoding on the video data stream UVS to generate a compressed video data stream CVS. The video data stream UVS includes a frame Fₙ. The bit rate control circuit 510 includes a texture calculating circuit 500, a protected color calculating circuit 502, a combining circuit 504 and an allocating circuit 506. The texture calculating circuit 500 performs step 102 and the texture analysis process 30 to obtain block texture weights BTW₁ to BTW_{M} corresponding to the encoding blocks CB₁ to CB_{M}. The protected color calculating circuit 502 performs step 104 and the protected color analysis process 40 on the frame Fₙ to obtain block protected color weights BCW ₁ to BCW_{M} corresponding to the encoding blocks CB₁ to CB_{M}. The combining circuit 504 performs step 106 to calculate the bit weights W₁ to W_{M} corresponding to the encoding blocks CB₁ to CB_{M} of the frame Fₙ. The allocating circuit 506 allocates appropriate numbers of bits to the encoding blocks CB₁ to CB_{M} according to the bit weights W₁ to W_{M} corresponding to the encoding blocks CB₁ to CB_{M}. The encoding circuit 508 performs video encoding on the encoding blocks CB₁ to CB_{M} of the frame Fₙ according to the numbers of bits allocated to the encoding blocks CB₁ to CB_{M}. One person skilled in the art can understand that, the texture calculating circuit 500, the protected color calculating circuit 502, the combining circuit 504, the allocating circuit 506 and the encoding circuit 508 may be application-specific integrated circuits (ASIC), and may be appropriately integrated based on designer needs instead of being individually independent integrated circuits.

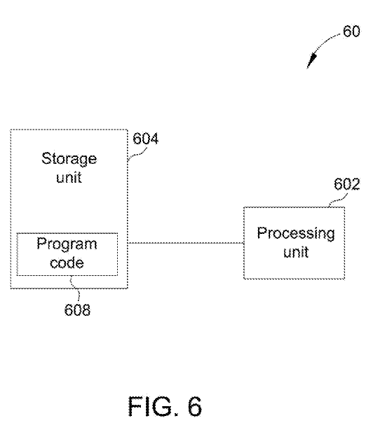

FIG. 6 shows a block diagram of a video encoding device 60 according to an embodiment of the present invention. The video encoding device 60 includes a processing unit 602 and a storage unit 604. The bit allocation process 10, the texture analysis process 30 and the protected color analysis process 40 may be coded into a program code 608 and stored in the storage unit 604. The program code 608 instructs the processing unit 602 to perform the bit allocation process 10, the texture analysis process 30 and the protected color analysis process 40. For example, the processing unit 602 may be a central processing unit (CPU), a digital signal processor (DSP) or a microprocessor. For example, the storage unit 604 may be a read-only memory (ROM), a non-volatile memory (e.g., an electrically erasable programmable read-only memory (EEPROM)) or a flash memory.

It should be noted that, the video encoding devices 50 and 60 are applicable to televisions, set-top boxes (STB), digital television sticks and webcams associated with video surveillance or video conference, and may allocate a greater number of bits to an encoding block having a higher spatial texture complexity and a higher protected color (skin color) pixel count, thereby providing the encoding block with better image quality to enhance perceptual visual quality.

It is to be understood that, one person skilled in the art may make different modifications to the foregoing embodiments intended for illustrating the concept of the present invention. For example, the bit weight Wᵢ is not limited to a linear combination of the block weight IBWᵢ, the block texture weight BTWᵢ and the block protected color weight BCWᵢ. For example, the bit weight Wᵢ may be calculated as Wᵢ=αf(lBWᵢ)+βf(BTWᵢ)+γf(BCWᵢ) or Wᵢ=(lBWᵢ)−^{α}*(BTWᵢ)^{β}*(BCWᵢ)⁷, where α, β and γ may be adjusted based on actual conditions, and such modifications are to be encompassed within the scope of the present invention. Further, given that an effect of high-pass filtering is achieved, the high frequency operation in step 102 is not limited to the two-dimensional Laplacian operation.

In conclusion, in the present invention, corresponding numbers of bits are allocated to a plurality of encoding blocks according to the spatial texture complexities and protected color pixel counts of these encoding blocks, thereby enhancing perceptual visual quality.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A bit allocation method, applied to a video encoding device, comprising:
performing a high frequency operation on a plurality of encoding blocks of a first frame to obtain a first block texture weight of a first encoding block among the plurality of encoding blocks;
performing a protected color detection operation on the plurality of encoding blocks to obtain a first block protected color weight corresponding to the first encoding block;
calculating a first bit weight corresponding to the first encoding block according to the first block texture weight and the first block protected color weight; and
performing bit allocation for the first encoding block according to the first bit weight.

2. The bit allocation method according to claim 1, wherein the high frequency operation is a two-dimensional Laplacian operation.

3. The bit allocation method according to claim 1, wherein the step of performing the high frequency operation on the plurality of encoding blocks to obtain the first block texture weight corresponding to the first encoding block comprises:
performing the high frequency operation on the plurality of encoding blocks to obtain a plurality of block texture complexities; and
calculating the first block texture weight according to the plurality of block texture complexities;
wherein, the first block texture weight is associated with a ratio of a first block texture complexity corresponding to the first encoding block to the plurality of block texture complexities.

4. The bit allocation method according to claim 3, wherein the step of performing the high frequency operation on the plurality of encoding blocks to obtain the plurality of block texture complexities comprises:
performing the high frequency operation on a plurality of pixels in a second encoding block among the plurality of encoding blocks to obtain a plurality of pixel texture results corresponding to the plurality of pixels; and
obtaining a second block texture complexity corresponding to the second encoding block according to the plurality of pixel texture results.

5. The bit allocation method according to claim 4, wherein the step of obtaining the second block texture complexity corresponding to the second encoding block according to the plurality of pixel texture results comprises:
obtaining a plurality of absolute values of the plurality of pixel texture results;
adding up of the plurality of absolute values to obtain a sum; and
obtaining the second block texture complexity according to the sum, wherein the second block texture complexity is associated with a reciprocal of the sum.

6. The bit allocation method according to claim 1, wherein the step of performing the protected color detection operation on the plurality of encoding blocks to obtain the first block protected color weight corresponding to the first encoding block comprises:
performing the protected color detection operation on the plurality of encoding blocks to obtain a plurality of block protected color levels; and
calculating the first block protected color weight according to the plurality of block protected color levels;
wherein, the first block protected color weight is associated with a ratio of a first block protected color level corresponding to the first encoding block to the plurality of block protected color levels.

7. The bit allocation method according to claim 6, wherein the step of performing the protected color detection operation on the plurality of encoding blocks to obtain the plurality of block protected color levels comprises:
performing the protected color detection operation on a plurality of pixels in a third encoding block among the plurality of encoding blocks to obtain a plurality of pixel protected color detection results corresponding to the plurality of pixels; and
obtaining a block protected color level corresponding to the third encoding block according to the plurality of pixel protected color detection results;
wherein, the block protected color level is associated with a sum of adding up the plurality of plurality of pixel protected color detection results.

8. The bit allocation method according to claim 1, wherein the first bit weight is a combination of the first block texture weight and the first block protected color weight.

9. The bit allocation method according to claim 1, further comprising:
calculating the first bit weight corresponding to the first encoding block according to a first block weight, the first block texture weight and the first block protected color weight.

10. The bit allocation method according to claim 1, wherein the high frequency operation comprises a first gradient operation performed along a first direction and a second gradient operation performed along a second direction.

11. A video encoding device, comprising:
a texture calculating circuit, performing a high frequency operation on a plurality of encoding blocks of a first frame to obtain a first block texture weight of a first encoding block among the plurality of encoding blocks;
a protected color calculating circuit, performing a protected color detection operation on the plurality of encoding blocks to obtain a first block protected color weight corresponding to the first encoding block;
a combining circuit, coupled to the texture calculating circuit and the protected color calculating circuit, calculating a first bit weight corresponding to the first encoding block according to the first block texture weight and the first block protected color weight; and
an allocating circuit, coupled to the combining circuit, performing bit allocation for the first encoding block according to the first bit weight.

12. The video encoding device of claim 11, wherein the high frequency operation is a two-dimensional Laplacian operation.

13. The video encoding device of claim 12, wherein, to perform the high frequency operation on the plurality of encoding blocks to obtain the first block texture weight corresponding to the first encoding block, the texture calculating circuit further performs steps of:
performing the high frequency operation on the plurality of encoding blocks to obtain a plurality of block texture complexities; and
calculating the first block texture weight according to the plurality of block texture complexities;
wherein, the first block texture weight is associated with a ratio of a first block texture complexity corresponding to the first encoding block to the plurality of block texture complexities.

14. The video encoding device of claim 13, wherein, to perform the high frequency operation on the plurality of encoding blocks to obtain the plurality of block texture complexities, the texture calculating circuit further performs steps of:
performing the high frequency operation on a plurality of pixels in a second encoding block among the plurality of encoding blocks to obtain a plurality of pixel texture results corresponding to the plurality of pixels; and
obtaining a second block texture complexity corresponding to the second encoding block according to the plurality of pixel texture results.

15. The video encoding device of claim 14, wherein, to obtain the second block texture complexity corresponding to the second encoding block according to the plurality of pixel texture results, the texture calculating circuit further performs steps of:
obtaining a plurality of absolute values of the plurality of pixel texture results;
adding up of the plurality of absolute values to obtain a sum; and
obtaining the second block texture complexity according to the sum, wherein the second block texture complexity is associated with a reciprocal of the sum.

16. The video encoding device of claim 11, wherein, to perform the protected color detection operation on the plurality of encoding blocks to obtain the first block protected color weight corresponding to the first encoding block, the protected color calculating circuit further performs steps of:
performing the protected color detection operation on the plurality of encoding blocks to obtain a plurality of block protected color levels; and
calculating the first block protected color weight according to the plurality of block protected color levels;
wherein, the first block protected color weight is associated with a ratio of a first block protected color level corresponding to the first encoding block to the plurality of block protected color levels.

17. The video encoding device of claim 16, wherein, to perform the protected color detection operation on the plurality of encoding blocks to obtain the plurality of block protected color levels, the protected color calculating circuit further performs steps of:
performing the protected color detection operation on a plurality of pixels in a third encoding block among the plurality of encoding blocks to obtain a plurality of pixel protected color detection results corresponding to the plurality of pixels; and
obtaining a block protected color level corresponding to the third encoding block according to the plurality of pixel protected color detection results;
wherein, the block protected color level is associated with a sum of adding up the plurality of plurality of pixel protected color detection results.

18. The video encoding device of claim 11, wherein the combining circuit calculates a combination of the first block texture weight and the first block protected color weight.

19. The video encoding device of claim 11, wherein the combining circuit calculates the first bit weight corresponding to the first encoding block according to a first block weight, the first block texture weight and the first block protected color weight.

20. The video encoding device of claim 11, wherein the high frequency operation comprises a first gradient operation performed along a first direction and a second gradient operation performed along a second direction.
